(19) United States
(12) Patent Application Publication
(10) Pub. No.: US 2012/0317756 A1
(43) Pub. Date: Dec. 20, 2012

(54) Invisible zipper with rectangular positioning unit

(76) Inventor: Chin-Shui YANG, Taipei City (TW)

(21) Appl. No.: 13/163,802

(22) Filed: Jun. 20, 2011

(51) Int. Cl. A44B 19/08; F16B 47/00

(52) U.S. Cl. 24/408

(57) ABSTRACT

An invisible zipper with a rectangular positioning unit includes two strips, teeth, a slide and a rectangular positioning unit. The two strips are sewed to an opening. The teeth are disposed along each strip. The slide is disposed on one of the strips and can slide along the two strips. The rectangular positioning unit is fixedly disposed at the end of one of the two strips. In use, the end of the other strip is inserted through the slide and into the rectangular positioning unit. Now, we can use the slide to bring together the two strips or separate them.

### BACKGROUND OF THE INVENTION

1. Field of the Invention

The invention generally relates to an invisible zipper with a rectangular positioning unit. More particularly, the invention relates to an invisible zipper with a rectangular positioning unit, which is separate from other components of the zipper and may be fitted easily so that such invisible zipper may be more widely used.

2. Description of the Prior Art

Because zippers are easy to use and can close an opening quickly, they have been widely used in clothes, accessories, shoes, etc.

As living standard gets higher, clothes become more aesthetically appealing. Because the teeth of traditional zipper are exposed after it is sewed to clothes, traditional zipper is less appealing. Therefore, the invisible zipper emerges.

The conventional invisible zipper comprises two strips, teeth, a slide and a rectangular fixing unit. The teeth are disposed along each strip. The rectangular fixing unit is disposed at the end of one of the strips. The slide is disposed on one of the strips. The rectangular fixing unit is used to fix the ends of the two strips. A user can use the slide to bring together or separate the two strips. The main difference between the conventional invisible zipper and the traditional zipper is the fact that the teeth and the slide are hidden on the inner side in the former so as to enhance the appearance.

However, because the rectangular fixing unit is relatively large, a sewing machine can not be used to sew it on. The ends of the two strips are usually joined together by adhesive. Therefore, the range of application of such zipper is substantially reduced because it can not be used in items requiring two strips whose ends are separate from each other, such as jackets, suits, etc.

An improved zipper would be the zipper of Taiwan Patent application No. 92,217,138 (certificate no. 219668, with the title of “invisible zipper with separate ends and a moveable fixing unit”), as illustrated in FIG. 8. In the improved zipper, a pin 14′ and 15′ is provided on each of the two strips 11′ and 12′ and the conventional rectangular unit is changed into a moveable unit 3′, which may be moved around so that the zipper may be sewed up.

However, because the moveable unit 3′ has to be disposed on one strip 11′, such moveable unit 3′ and pins 14′ and 15′ are structurally complicated to keep it on the strip 11′. Therefore, costs of material and manufacturing are increased and non-conforming rate is high. As a result, such zipper has not been widely used.

From the above, we can see that the conventional zippers of have many disadvantages and need to be improved.

To eliminate the disadvantages of the conventional zippers, the inventor has put a lot of effort into the subject and has successfully come up with the invisible zipper of the present invention.

### SUMMARY OF THE INVENTION

An object of the present invention is to provide an invisible zipper with a rectangular positioning unit, which is separate from other components of the zipper and may be fitted easily, so that such invisible zipper may be more widely used.

Another object of the present invention is to provide an invisible zipper that is structurally simple and of low production cost and may be widely used.

To reach these objects, the invisible zipper of the present invention is disclosed. The invisible zipper of the present invention comprises two strips, teeth, a slide and a rectangular positioning unit. The two strips are sewed to an opening. The teeth are disposed along each strip. The slide is disposed on one of the strips and can slide along the two strips. In use, the ends of the two strips are inserted through the slide and into the rectangular positioning unit. Now, we can use the slide to bring together the two strips or separate them. After the fixing pin is inserted into the fixing groove, adhesive is used to bond them together and fill in the gap. Alternatively, a bolt and a threaded hole may be used to fix the rectangular positioning unit so that the rectangular positioning unit may be taken off and replaced easily.

### BRIEF DESCRIPTION OF THE DRAWINGS

The features and advantages of the present invention will be fully understood and appreciated from the following detailed description of the preferred embodiment and the accompanying drawings.

FIG. 1 is a partially sectional view of the invisible zipper of the present invention.

FIG. 2 is a plan view of the invisible zipper of the present invention.

FIG. 3 is a view illustrating how the two strips are separated.

FIG. 4 is a view illustrating how the two strips are brought together.

FIG. 5 is a view illustrating the inner side of the zipper when the two strips are brought together.

FIG. 6 is a view illustrating how adhesive is used.

FIG. 7 is a view illustrating how a bolt and a threaded hole are used to fix the fixing pin with the positioning unit.

FIG. 8 is an exploded view of the conventional zipper.

### DETAILED DESCRIPTION OF THE PREFERRED EMBODIMENT

The features and advantages of the present invention will be fully understood and appreciated from the following detailed description of the preferred embodiment and the accompanying drawings.

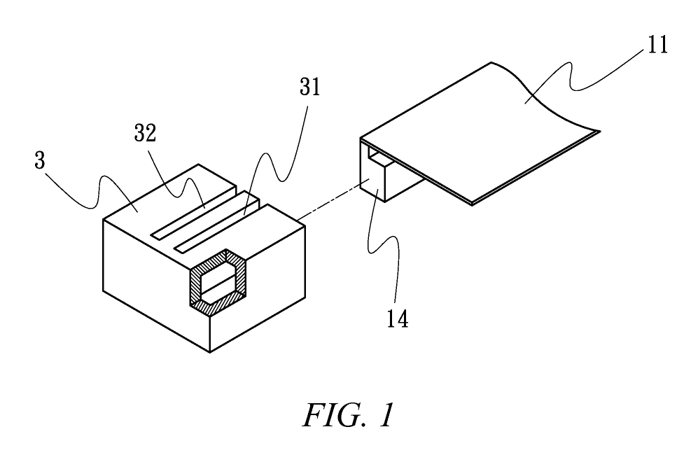

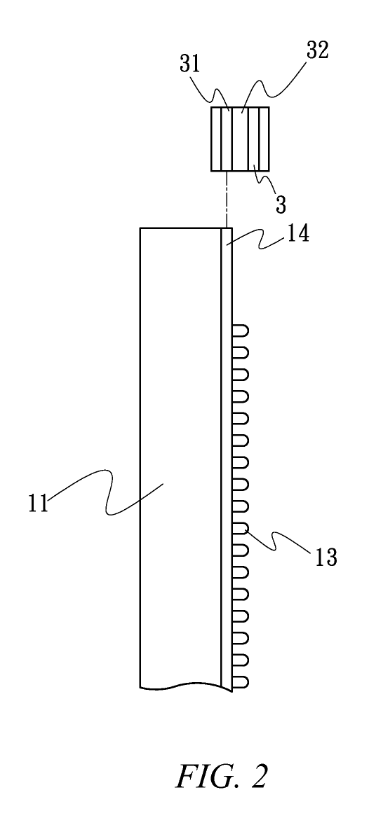

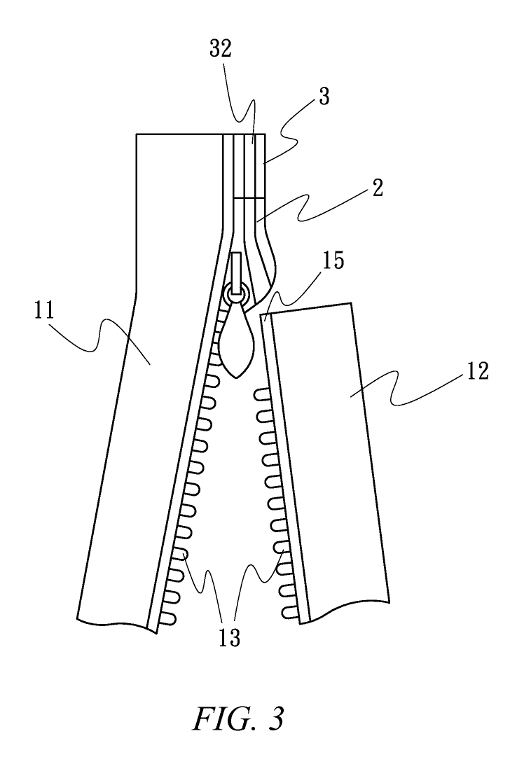

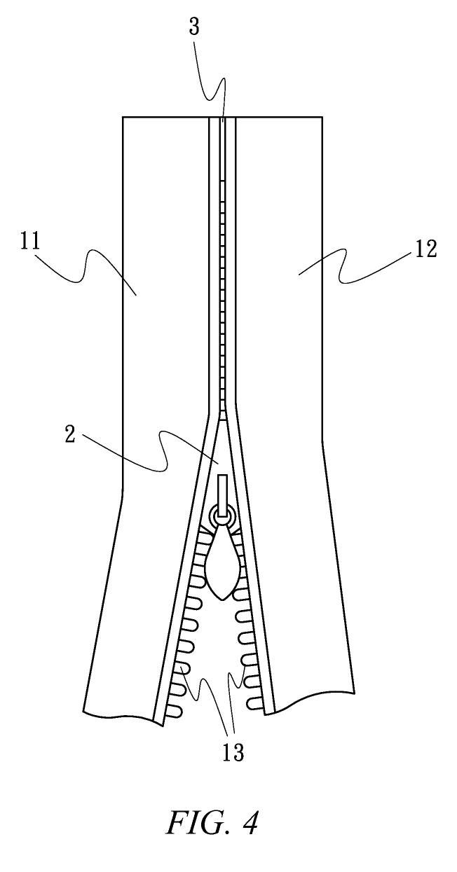

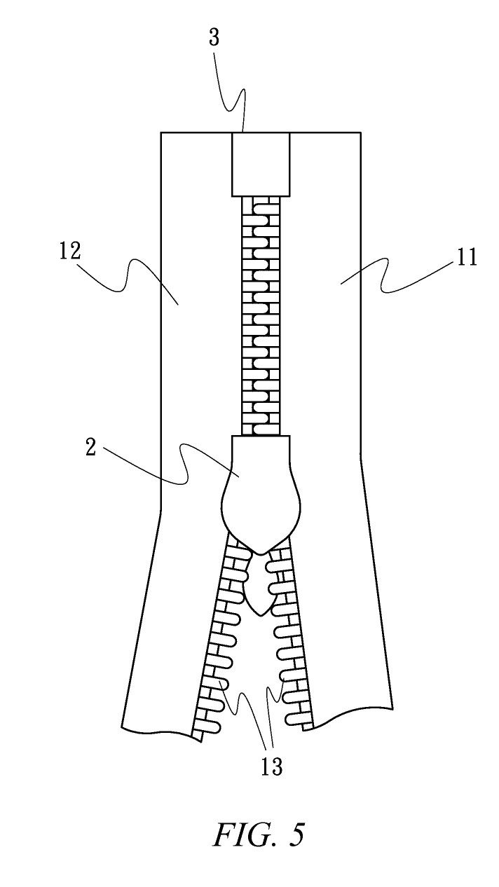

Please refer to FIGS. 1 to 5, which illustrate the invisible zipper of the present invention. The invisible zipper comprises two strips 11 and 12, teeth 13, a slide 2 and a rectangular positioning unit 3. The two strips 11 and 12 are sewed to an opening. The teeth are disposed along each strip 11. The slide 2 can slide along the two strips. Before use, the two strips are separate from each other. In use, the end of the other strip 12 is inserted into the slide 2 and we can then use the slide 2 to close and open the zipper.

To make the zipper of the present invention “invisible”, a rectangular positioning unit 3 is disposed at the end of the strip 11. In use, the end of the other strip 12 is inserted into the rectangular positioning unit 3 and then we can use the slide 2 to bring together the two strips.

In production, the two strips and the rectangular positioning unit 3 are fitted separately. First, the two strips are sewed to the two sides of an opening; then, the rectangular positioning unit 3 is fixed at the end of the strip 11. A fixing groove 31 and a positioning groove 32 are provided in the positioning unit 3 and one end of either the fixing groove 31 and or the positioning groove 32 is closed (i.e., either groove is shorter than the length of the rectangular positioning unit 3). A fixing pin 14 is provided at the end of the strip 11 so that the fixing pin 14 is fixed in the fixing groove after the two strips are sewed. In addition, the rectangular positioning unit 3 and the slide 2 are disposed on the same side of the same strip 11. A positioning pin 15 is disposed at the end of the other strip 12. In use, the positioning pin 15 is inserted through the slide 2 and is then anchored and fixed in the positioning groove 32. Therefore, we may use the slide 2 to bring together or separate the two strips 11 and 12.

To make the zipper invisible, the teeth 13, the slide 2 and the protruding surface of the positioning unit 3 are oriented towards the inside of the zipper. Therefore, the teeth 13, the slide 2 and the positioning unit 3 are virtually hidden and hence the zipper becomes more aesthetically appealing. The fixing pin 14 is perpendicular to the strip 11 so as to allow the strip 11 to lie upon and cover the rectangular positioning unit 3 after the fixing pin 14 is inserted into the rectangular positioning unit 3 and to make the zipper invisible.

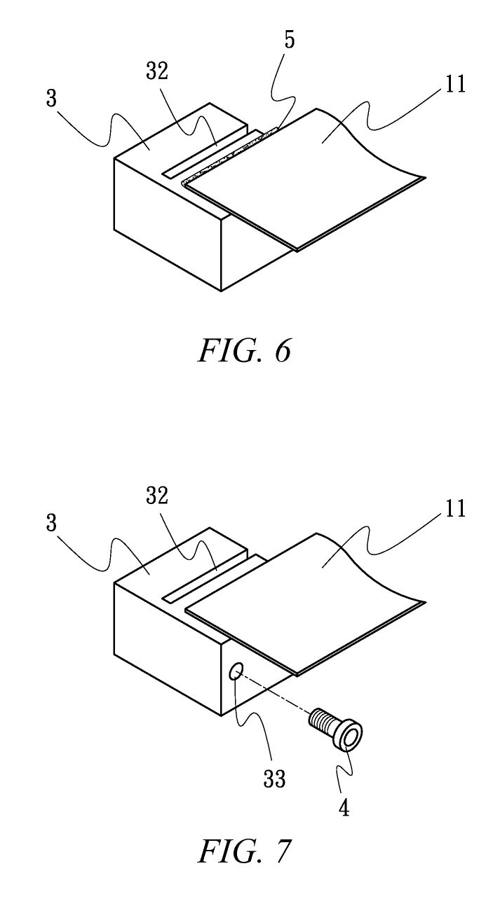

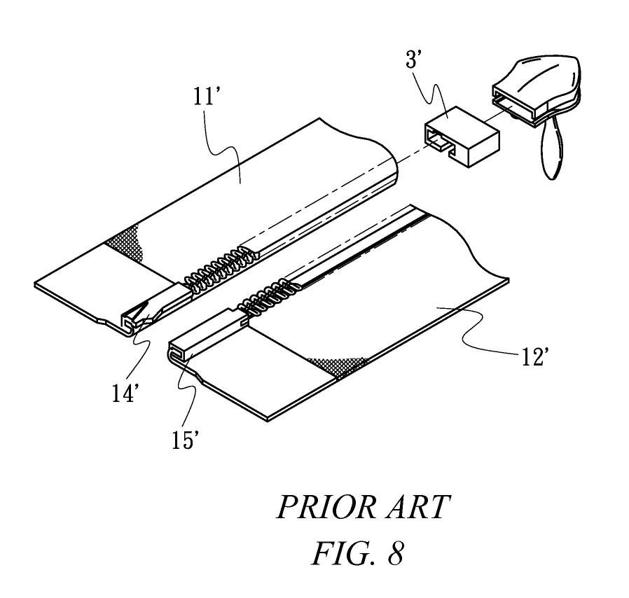

As illustrated in FIG. 6, after the fixing pin 14 is inserted into the fixing groove 31, adhesive 5 is used to bond them together and fill in the gap. The adhesive 5 may be water-proof adhesive, AB adhesive (a mixture of epoxy resin and hardener), modified polyamide resin, etc. Alternatively, a bolt and a threaded hole may be used to fix the fixing pin with the rectangular positioning unit 3. As illustrated in FIG. 7, a threaded hole 33 may be provided on a side of the positioning unit 3 and a bolt 4 may be used to fix the fixing pin 14 with the positioning unit 3. The advantage of the use of a bolt 4 is the ease of the disassembly of the rectangular positioning unit 3.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A zipper, comprising:
two strips;
a plurality of teeth, disposed on each of the two strips;
a slide, disposed on one of the two strips;
a rectangular positioning unit, having a fixing groove and a positioning groove, wherein either the fixing groove or the positioning groove has a closed end;
a fixing pin, disposed on one strip; and
a positioning pin, disposed on the other strip;
wherein the fixing pin is inserted into the fixing groove and is fixed in the fixing groove;
wherein, in use, the positioning pin is positioned in the positioning groove so that the slide can be used to bring together or to separate the two strips.

2. The zipper as claimed in claim 1, wherein the rectangular positioning unit and the slide are disposed on the same side of the strip.

3. The zipper as claimed in claim 1, wherein the fixing pin and the fixing groove are bonded together by an adhesive.

4. The zipper as claimed in claim 3, wherein the adhesive is a water-proof adhesive, a mixture of epoxy resin and hardener, or a modified polyamide resin.

5. The zipper as claimed in claim 1, further comprising a bolt and a threaded hole which are used to fix the fixing pin with the rectangular positioning unit.

6. The zipper as claimed in claim 1, further comprising a bolt and a threaded hole, wherein the threaded hole is disposed on a side of the positioning unit, and the bolt is used to fix the fixing pin with the positioning unit.

7. The zipper as claimed in claim 1, wherein the fixing pin is perpendicular to the strip so as to allow the strip to lie upon and cover the rectangular positioning unit when the fixing pin is inserted into the rectangular positioning unit and to make the zipper invisible.

8. The zipper as claimed in claim 1, wherein the teeth, the slide and a protruding surface of the rectangular positioning unit are oriented towards the inside of the zipper.
